(19) United States
(12) Patent Application Publication
(10) Pub. No.: US 2015/0316738 A1
(43) Pub. Date: Nov. 5, 2015

(54) FIBER OPTIC CABLE HOLDER FOR A CASSETTE

(71) Applicant: CORNING OPTICAL COMMUNICATIONS LLC, HICKORY, NC (US)

(72) Inventors: William Julius McPhil Giraud, Azle, TX (US); Diana Rodriguez, Fort Worth, TX (US)

(21) Appl. No.: 14/704,367

(22) Filed: May 5, 2015

Related U.S. Application Data
(60) Provisional application No. 61/988,628, filed on May 5, 2014.

(51) Int. Cl. G02B 6/44

(52) U.S. Cl. CPC G02B 6/4454

(57) ABSTRACT

Embodiments of fiber optic cable holders will now be described with reference to the figures. Embodiments relate to a fiber optic cable holder having a cable receiver at a first end, an attachment feature at a second end and an arm between the cable receiver and the attachment feature. The attachment feature is configured to toollessly attach and detach the fiber optic cable holder from a fiber optic cassette and the cable receiver is adapted to receive fiber optic cables such that the fiber optic cable holder supports and maintains fiber optic cables even when a cable routing tray is in an open or close position.

### PRIORITY APPLICATION

This application claims the benefit of priority under 35 U.S.C. §119 of U.S. Provisional Application Ser. No. 61/988,628 filed on May 5, 2014, the content of which is relied upon and incorporated herein by reference in its entirety.

### BACKGROUND

1. Field of the Disclosure

The disclosure relates generally to optical cable apparatus more particularly to fiber optic cable holders attachable to cassettes.

2. Technical Background

In optical cable networking apparatus including convergence points and distribution frames, such as in fiber-optics networking, there is a constant demand for components permitting high-density distribution with very high fiber termination counts in a small, confined volume. The distribution frames may be located in central offices while the convergence points may be outdoor cabinets located throughout the network. Accomplishing the high-density distribution with high fiber termination counts requires efficient utilization of space with due regard to constraints put on optical cables, such as minimum bending radius. As such, an ongoing need exists for optical-cable networking components that can effectively utilize a confined volume when large numbers of optical cables are present, while simultaneously avoiding sharp bends to the optical cables.

### SUMMARY

Embodiments relate to a fiber optic cable holder having a cable receiver at a first end, an attachment feature at a second end and an arm between the cable receiver and the attachment feature. The attachment feature is configured to toollessly attach and detach the fiber optic cable holder from a fiber optic cassette and the cable receiver is adapted to receive fiber optic cable such that the fiber optic cable holder supports and maintains fiber optic cables even when a cable routing tray is in an open or close position.

Additional features and advantages will be set forth in the detailed description which follows, and in part should be readily apparent to those skilled in the art from the description or recognized by practicing the embodiments as described in the written description and claims hereof, as well as the appended drawings. It is to be understood that both the foregoing general description and the following detailed description describe various embodiments and are intended to provide an overview or framework for understanding the nature and character of the claimed subject matter.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective top view of a fiber optic cable holder according to an exemplary embodiment;

FIG. 2 is a partial perspective top view of an adapter holder for a cassette to which the fiber optic cable holder of FIG. 1 may toollessly attach and detach;

FIG. 3 is a perspective top view of a cassette with the fiber optic cable holder attached to the adapter holder and holding multiple fiber optic cables with a cable routing tray having a drop handle pivoted downward such that cable routing tray is not in position to support fiber optic cables;

FIG. 4 is a partial perspective top view of the cassette of FIG. 3 with the drop handle pivoted upward such that cable routing tray is in position to support the fiber optic cables;

FIG. 5 is a partial perspective top view of the cassette of FIG. 4 with a label cover closed; and

FIG. 6 is a perspective top view of a fiber optic cable holder according to an exemplary embodiment.

### DETAILED DESCRIPTION

Embodiments of fiber optic cable holders will now be described with reference to the figures. Embodiments relate to a fiber optic cable holder having a cable receiver at a first end, an attachment feature at a second end and an arm between the cable receiver and the attachment feature. The attachment feature is configured to toollessly attach and detach the fiber optic cable holder from a fiber optic cassette and the cable receiver is adapted to receive fiber optic cables such that the fiber optic cable holder support and maintain fiber optic cables even when a drop handle of a cable routing tray pivots to move the cable routing tray to an open or close position. The fiber optic cable holder may reduce fiber optic cable movement while the drop handle is pivoted downward to the open position, which will protect the fibers in the fiber optic cables from any increase in signal attenuation due to fiber movement. Additionally, fiber optic cable holder may reduce the risk of fiber breakage when pivoting the drop handle to the close position because fiber optic cable holder maintains the organization of the fiber optic cables while they are being accessed.

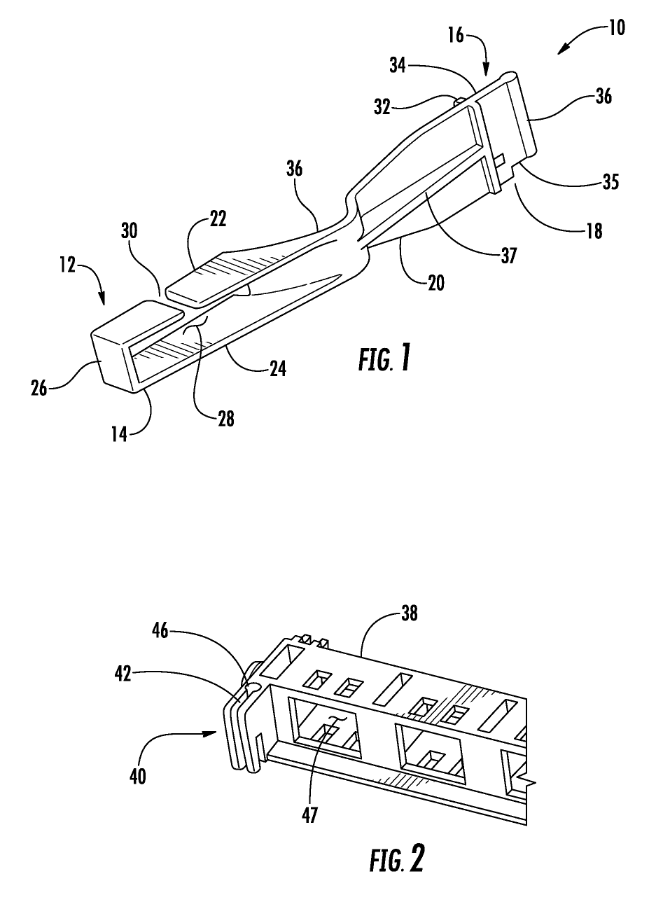

Referring to FIG. 1 there is shown a fiber optic cable holder 10. The fiber optic cable holder has a cable receiver 12 at a first end 14 and an attachment feature 16 at a second end 18 and arm 20 therebetween. Cable receiver 12 has a first wall 22, second wall 24 and end wall 26 defining a space 28 adapted to receive fiber optic cables (not shown) such that fiber optic cables may route through space 28 and be maintained by cable receiver 12. First wall 22 may have a slot 30 which may be used to insert fiber optic cables into space 28 and, thereby, cable receiver 12. Slot 30 may be positioned such that fiber optic cables may not be unintentionally removed or fall out from cable receiver 12. Attachment feature 16 has wall 32 and tab 34 having a straight section 35 and arcuate terminus 36 extending from wall 32 and with a diameter “D” sized to be larger than the transverse width “W” of tab 34. Arm 20 may have structural features 36 which may be configured to align with complementary features of or otherwise accommodate cable routing tray (not shown in FIG. 1). Additionally, brace 37 may extend from arm 20 to provide arm 20, and thereby, fiber optic cable holder 10, structural strength. Fiber optic cable holder 10 may be constructed, formed or molded of any suitable, as non-limiting examples, plastic or metal.

Turning now to FIG. 2, there is illustrated one end of adapter holder 38. Adapter holder 38 may have a receiver 40 with open elongated channel 42 having opposing straight walls 44 and arcuate end 46 forming an open generally elongated key shape. Channel 42 is adapted to receive attachment feature 18 of fiber optic cable holder 10 as will be described in more detail below. Adapter holder 38 may have multiple adapter slots 47 adapted to receive fiber optic adapters (not shown in FIG. 2) such that a fiber optic adapter may seat within slot 46.

In certain embodiments, attachment feature 18 and receiver 40 may be configured to form an interference fit to secure fiber optic cable holder 10 to cassette 48 without requiring additional tools or fasteners. Alternatively or additionally, attachment feature 18 and receiver 40 may be configured with complementary tabs/detents to form a “snap-fit” or “press-fit” interface to toollessly secure fiber optic cable holder 10 to cassette 48.

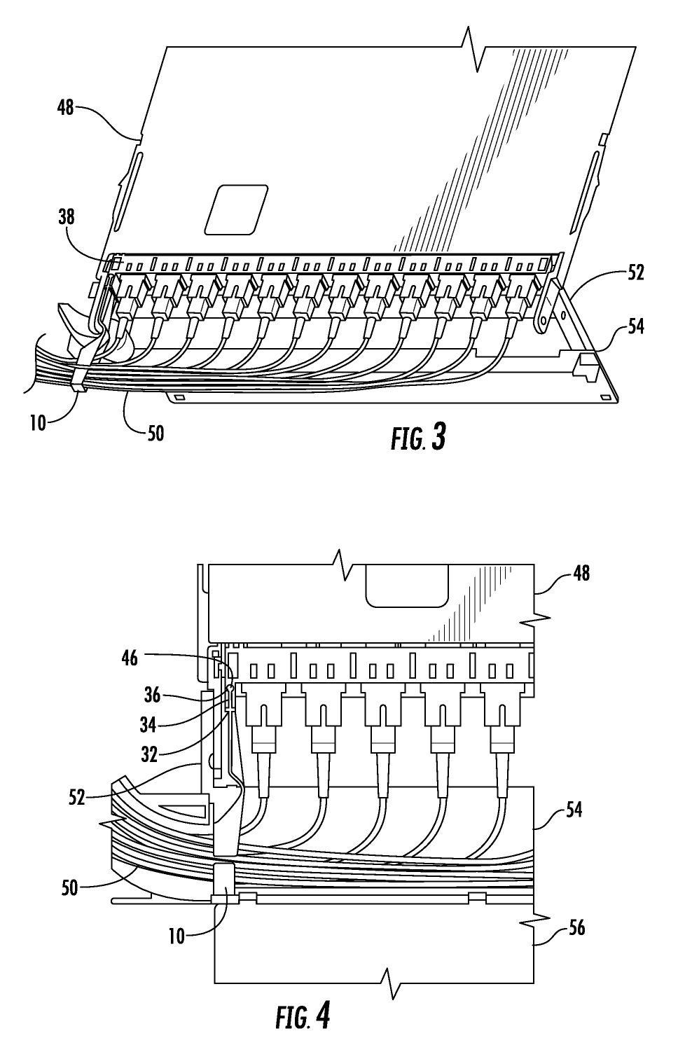

FIGS. 3, 4 and 5 show fiber optic cable holder 10 attached to adapter holder 38 positioned in cassette 48 and holding fiber optic cables 50. Tab 34 of attachment feature 16 is shown inserted in receiver 40 with straight section 35 within channel 42 and arcuate terminus 36 in arcuate end 46. Wall 32 interfaces with the open end of channel 42. In this manner, fiber optic cable holder 10 may be toollessly attached to and detached from cassette 48. Additionally, structural feature 36 positions in a manner to accommodate a feature of cable routing tray 54. As shown in FIG. 3, fiber optic cables 50 received by cable receiver 12 of fiber optic cable holder 10 may be supported and maintained even when drop handle 52 of cable routing tray 54 is pivoted downward to the open position during which fiber optic cables 50 are not supported by cable routing tray 54.

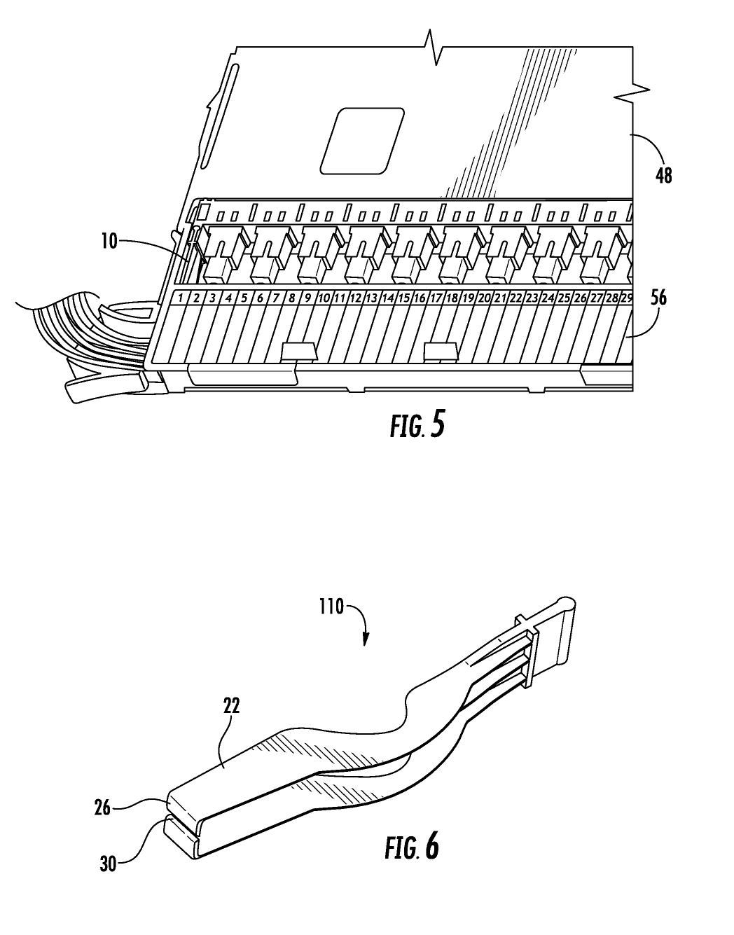

In this manner, the fiber optic cable holder 10 may reduce fiber optic cable 50 movement while the drop handle 52 is pivoted downward to the open position, which will protect the fiber in the fiber optic cables 50 from any increase in signal attenuation due to fiber movement. Additionally, fiber optic cable holder 10 may reduce the risk of fiber breakage when pivoting the drop handle 52 to the close position because fiber optic cable holder 10 maintains the organization of the fiber optic cables 50 while they are being accessed. FIG. 4 illustrates drop handle 52 is the close position with label cover 56 open, while FIG. 5 illustrates drop handle 52 is the close position with label cover 56 closed. As can be seen from FIG. 5, when label cover 56 is closed, a portion of fiber optic cable holder 10 is hidden.

Referring now to FIG. 6 there is illustrated fiber optic cable holder 110. The features of fiber optic cable 110 that are the same as fiber optic cable holder 10 will not be discussed again as the discussion of those features with respect to fiber optic cable holder 10 applies to fiber optic cable holder 110. As can be seen in FIG. 6, slot 30 is not located on first wall 22 but, instead, on end wall 26. This change allows the fiber optic cable holder to be attached to both the right and left ends of the adapter holder 38. The fiber optic adapter holder 110 is inverted when being attached to the other end of adapter holder 38, but attaches in the same manner as described above with respect to fiber optic cable holder 10. In this way, fiber optic adapter holder 110 may be configured to attach to either end of adapter holder 38, and thereby either side of cassette 48.

Cassette 48 may include a tray base having a tray top surface. A tray center portion may be defined on the tray top surface inside a plurality of tray cable securing members arranged around a center-portion periphery of the tray center portion. The tray center portion may have a tray proximal zone and a tray distal zone defined thereon. The cassette 48 may further include a device holder removably and hingedly attached to the tray base and having a holder-closed position and a holder-open position. The device holder may include a holder inner surface and a holder outer surface opposite the holder inner surface. The holder inner surface may have a holder proximal zone and a holder distal zone defined thereon. The device holder may include a plurality of holder cable securing members arranged around a holder periphery of the device holder. At least one device securing member may be disposed in the holder proximal zone and configured to secure an optical device to the holder inner surface. When the device holder is in the holder-closed position and an optical device is secured in the at least one device securing member of the device holder, the holder distal zone overlies the tray distal zone and the optical device overlies the tray proximal zone.

In some embodiments the cassette 48 may contain one or more additional features shown in the figures. For example, the cassette 48 may include an adapter bank that includes a plurality of adapters for connecting external devices (not shown) to optical cables within the cassette 48. As another example of an additional feature, the cassette 48 may include a drop handle having a cable guidance end. The drop handle may cover the adapter panel when the adapter panel is not in use or may protect connectors that are plugged into the adapter panel when the adapter panel is in use. The drop handle also may include a pivot or hinge that allows the drop handle to swing up and down to provide access to the adapter panel.

As another example of an additional feature, the cassette 48 may include a tray cover hingedly attached to the tray base on a side of the tray base by a cover hinge, for example. In such embodiments, the tray cover may be made of a transparent or translucent material that enables a technician to view connections and devices on the tray base through the tray cover.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic cable holder, comprising:
a first end and a second end;
a cable receiver at the first end;
an attachment feature at the second end; and
an arm between the cable receiver and the attachment feature,
wherein the attachment feature toollessly attaches and detaches the fiber optic cable holder from a fiber optic cassette.

2. The fiber optic cable holder of claim 1, wherein the attachment feature is configured to slideably connect to the fiber optic cassette.

3. The fiber optic cable holder of claim 2, wherein the attachment feature is configured to form an interference fit with the fiber optic cassette.

4. The fiber optic cable holder of claim 2, wherein the first attachment is configured to form a snap-fit with the fiber optic cassette.

5. The fiber optic cable holder of claim 1, wherein the attachment feature is integral to the latching assembly.

6. The fiber optic cable holder of claim 5, wherein the attachment feature is manufactured from the same material as the latching assembly.

7. A splice cassette, comprising:
a housing defining a center portion configured to store fiber optic cable;
a cable routing tray positioned toward the front of the housing and configured to support one or more fiber optic cables positioned thereon; and
a fiber optic cable holder, removably coupled to at least a portion of the splice cassette, comprising:
a first end and a second end;
a cable receiver at the first end;
an attachment feature at the second end; and
an arm between the cable receiver and the attachment feature,
wherein the attachment feature toollessly attaches and detaches the fiber optic cable holder from a fiber optic cassette.

8. The splice cassette of claim 7, wherein the attachment feature is configured to slideably connect to the fiber optic cassette.

9. The splice cassette of claim 8, wherein the attachment feature is configured to form an interference fit with the fiber optic cassette.

10. The splice cassette of claim 8, wherein the first attachment is configured to form a snap-fit with the fiber optic cassette.

11. The splice cassette of claim 7, wherein the attachment feature is integral to the latching assembly.

12. The splice cassette of claim 11, wherein the attachment feature is manufactured from the same material as the latching assembly.
